(19) United States
(12) Patent Application Publication
(10) Pub. No.: US 2018/0023508 A1
(43) Pub. Date: Jan. 25, 2018

(54) Two Cylinder Double Acting Stirling Engine

(71) Applicant: Ali Javaherpour, Tehran (IR)

(72) Inventor: Ali Javaherpour, Tehran (IR)

(21) Appl. No.: 15/217,929

(22) Filed: Jul. 22, 2016

(51) Int. Cl. F02G 1/044

(52) U.S. Cl. CPC F02G 1/044; F02G 2243/32; F02G 2270/40

(57) ABSTRACT

A thermodynamic machine designed as a two cylinder engine, working as a double acting Stirling engine. This new model of Stirling engine consists of two cylinders and three pistons of equal diameter. Pistons reciprocate in cylinders, move gas and run Stirling cycle. The gas in each cylinder is transferred to the other cylinder through pipes and the gas is displaced between hot end of engine and cold end of engine by means of these pipes. Each cylinder contains a hot end or a hot zone and a cold end or a cold zone. Thereby there are two Stirling cycles operating simultaneously but with phase offset in this engine.

### BACKGROUND OF INVENTION

History of Stirling engines refer to late 19^{th} century. Basic models of Stirling engine are ALPHA, BETA and GAMMA. Actually a common double acting engine is a kind of Alpha type. Utilizing Stirling engines in solar power plants and investing in this field caused promotion of this industry and double acting Stirling engine knowledge. Common double acting Stirling engines are comprised of four cylinders and are known as SIEMENS or RINIA Stirling engines.

Due to higher mechanical efficiency in Stirling cycle, the double acting Stirling engines are better in performance compared to single acting Stirling engines. Having more moving parts and more gas flow pipes, which is two to four times more than alpha type single acting engines, have made these engines more expensive, more complicated and more difficult to produce.

Advantages of a double acting engine with a two cylinder structure has been presented in previous models of Two Cylinder Double Acting Stirling engines, but still there are some obvious problems in utilization in field of renewable energies.

One of the most keynote challenges in designing a double acting Stirling engine for renewable—especially solar—applications is where to locate the focal point for heat absorption. A common double acting Stirling engine requires more than one focal point of solar radiation since it has four hot points in its structure. Hot points usually in these engines are top of cylinders. This challenge made it intricate to design a double acting engine for solar applications and will influence layout of engine parts. The other challenge is sealing pistons in hot zones of engine.

Generally single acting Stirling engines need a heavier fly wheel compared to double acting ones in order to fulfill required energy for engine in compression step or moving pistons out from dead center. Also because of this demand, the engine requires more restarting force when it is going to start. When engine's mean pressure becomes higher, this problem becomes more crucial. But this issue mostly has been solved in multi cylinder and double acting Stirling engines; as the energy needed to compress the gas in a cylinder is provided by adjacent cylinders expansion energy.

Another problem that exists in common four cylinder double acting Stirling engines is, four separated gas flow paths. These paths connect cylinders to adjacent cylinders. Since heat exchangers or hot zones of these engines are located on the tubes that conduct gas flow, there must be four different spots to concentrate heating focus. Or in cases that is necessary to utilize one single concentrated source of energy. For example for Solar Stirling dishes, there is no solution but collecting these 4 points in a place in the middle of cylinder heads. This solution has got some unpleasant consequences. One of these consequences is increasing engines' dead space due to changing cylinder head's chamber shape.

The other topic concerning with these consequences in a four cylinder double acting engine is necessity of absorbing equal heat amount on each of 4 cylinder heat exchangers. Inasmuch as there are more than one cylinder and 4 Stirling cycles, it is important to obtain equal temperature in each cycle in order to operate properly. So there must not be any priority for none of cylinders to absorb more amount of thermal energy than the others.

It is easier to manage in a TCDA Stirling than a four cylinder one. Pumping loss in heat exchangers tubes is another important issue in Stirling engines. In a four cylinder double acting Stirling engine there are twice more paths and tubes than a two cylinder double acting Stirling engine. So it can be expressed that this newly innovated TCDA Stirling engine has got the advantages and simplicity of a single acting engine in addition to good performance of a double acting engine.

### Disadvantages of Previous Models:

As mentioned above, single acting Stirling engines are less in efficiency than double acting Stirling engines. The weak spot of four cylinder double acting Stirling engine has a complicated structure and design, compared to single acting engines. Since the thermal energy delivered to engine must heat the operating gas, it won't be ideal if engine parts absorb heat. This difficulty will be more crucial when energy source is direct sunlight. Despite the fact that delivering equal amount of heat to each cycle is partially solved in Hirata two cylinder double acting Stirling engine, important weak point is demand for using expensive materials to seal the pistons in cylinders. Sealing reciprocating parts in high temperature segments is a challenging matter in Hirata engine.

Deficits which were Sensed:

Therefore a lack of an integration of good performance of a double acting engine and structural simplicity and heat transfer simplicity of a single acting engine was sensed. In addition difficulties of manufacturing, maintenance and demand for expensive materials was considered to be less so that an economic product for electricity generation is presented.

### BRIEF DESCRIPTION OF DRAWING

FIG. 1: schematic structure of innovated two cylinder double acting Stirling engine.

FIG. 2: Cut away diagram of an inline arranged Stirling engine with heat exchanger 25 intended to use concentrated solar radiation as the heat source.

FIG. 3: Cylinder C1 and its components, front view and side view.

FIG. 4: Cylinder C2 and its components, front view and side view.

FIG. 5: Pistons and their components

FIG. 6: Perspective view of engine showing gas flow path 1

FIG. 7: Perspective view of engine showing gas flow path 2

FIG. 8: Side view of engine and its components.

FIG. 9: Wire frame perspective view of engine and its components.

FIG. 10: Perspective view of engine.

FIG. 11: Another perspective view of engine.

FIG. 12: Perspective view of gas pipe 35 and its particles.

FIG. 13: Upside view of Engine

FIG. 14: Side view of engine showing C1 cylinder in front and C2 cylinder behind it (heat exchanger pipes 25).

FIG. 15: Cut away perspective view of V shape arrangement with flat heat exchanger intended for solar purpose.

FIG. 16: Another cut away perspective view of V shape arrangement with flat heat exchanger intended for solar purpose.

FIG. 17: Cut away perspective view of V shape arrangement with round heat exchanger intended for burner (biogas).

FIG. 18: Cut away side view of V shape arrangement with round heat exchanger intended for burner (biogas).

FIG. 19: SIN θ diagram.

FIG. 20: phase of revolution and SIN diagram.

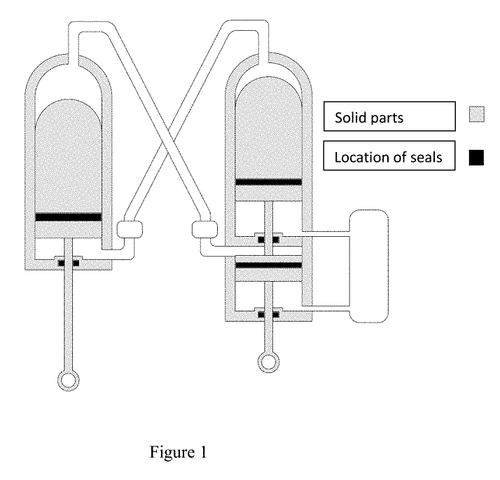

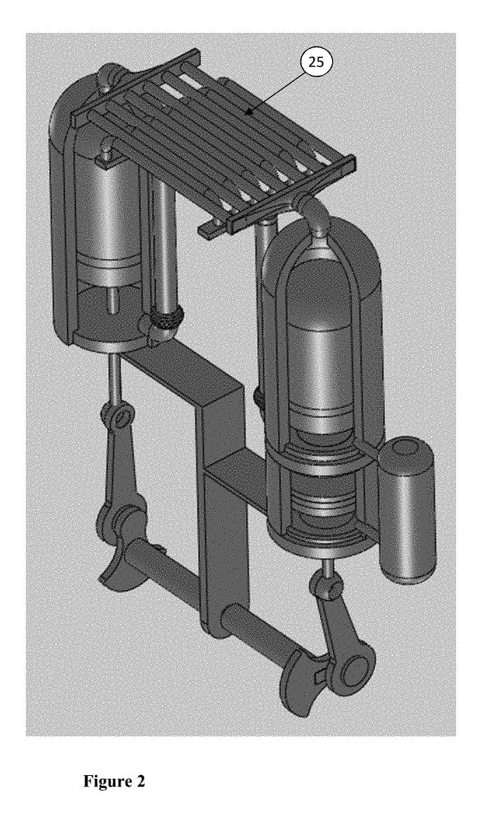

### SUMMARY OF INVENTION

The two cylinder double acting Stirling engine could ease the utilization of Stirling engines for renewable purposes. Renewable applications are solar and CHP biogas Stirling generators.

A new design was implemented to improve the performance of this engine and reducing its moving parts. The gas path for engine was reduced from 4 to 2 which will decrease pumping loss in the new double acting engine in comparison with previous models. Reducing total parts of engine will bring about a decrease in total production costs.

Although in four cylinder double acting Stirling engines it is difficult to bring gas pipes near each other since this will increase the dead space of engine, however in this invention this problem has been completely solved.

When gas pipes are brought near to each other in a place; it means that you can use a single heat source for both or all of cylinders. This action will optimize the performance of heat exchanger and heat absorption from heat source. It will lead to using concentrated solar radiation in very easy way. This concentration locus is named focal point with very high temperature. High temperature difference in Stirling engines drastically busts the efficiency of engine. In previous models of Double acting engine, this trend would consequent in much more dead space and lower efficiency.

In this invention a double acting Stirling engine with the fewest possible moving parts was designed. Dead space is minimal, although two Stirling cycles work by means of three pistons in two cylinders. This is the most important difference between this invention and previous models of Stirling engine. Unique design of mentioned engine simplifies maintenance of engine because of easy access to its parts.

There are totally four chambers in these two cylinders for working fluid. In each cylinder two chambers exist, with one is a hot chamber in each cylinder and the other one is a cold chamber in each cylinder. Sealing locations in this invention is placed in cold zones of engine so that there are many advantages in this case. Cheaper sealing materials and more durability are of these advantages. Smaller shade of engine in solar applications due to its compact design and structure is another advantage of this invention.

This innovatively designed engine presents performance of a double acting engine without any extra intricacy just utilizing two cylinders and three pistons. With a good layout and arrangement of engine parts it was made possible to seal hot zones of gas cycle without any need to ceramic seals or expensive materials but ordinary seals. In addition since some parts as push rods have been located in cold zones there would be no creep happening in their substances.

Guaranteeing the thermal feeding of each Stirling cycle equally; is one of the most important achievements in this design. Utilizing a concentrated heat source became highly possible and better than previous models.

Regarding implementing of important basics of designing due to increase performance and simplifying maintenance, an engine has been presented which in addition to operational advantages is very simple.

### BRIEF DESCRIPTION OF PARTS

8 Cold gate way of C1 cylinder
9 Hot gate way of C1 cylinder
10 C1 cylinder body
11 Expansion chamber of C1 cylinder
12 Compression chamber of C1 cylinder
13 Bottom cap of C1 cylinder
14 C2 cylinder upper body
15 C2 cylinder separator wall
16 C2 cylinder lower body
17 Bottom cap of C2 cylinder
18 P1 piston
19 PB1 piston
20 PB2 piston
21 Expansion chamber of C2 cylinder
22 Compression chamber of C2 cylinder
23 Hot gate way of C2 cylinder
24 Cold gate way of C2 cylinder
25 Hot zone heat exchanger of gas pipe(s)
26 P1 piston push rod
27 Push rod between PB1 & PB2
28 PB2 piston push rod
29 Connecting rod(s)
30 Crankshaft
31 Neutral chamber beneath PB1 piston
32 Neutral chamber beneath PB2 piston
33 Neutral chambers gate ways
34 Buffer vessel (connected to neutral chambers)
35 Gas pipe (s)
36 Regenerator
37 Cold zone heat exchanger of gas pipe(s)
38 Cold end of gas pipe
39 Hot end of gas pipe

Note: Figures with numbers 2, 15, 16, 17 & 18 are intended to show the simplicity of layout and arrangement of heat exchanger (shown as pipes) in various models. There are a bunch of pipes demonstrated for every cylinder and each of two paths, so that the pipes laid beside each other in a row can be seen.

### DETAILED DESCRIPTION OF SPECIFICATIONS

This Stirling engine is comprised of three pistons (pistons P1, PB1& PB2) of equal diameter, reciprocating in two cylinders (cylinders C1& C2). Two separated Stirling cycles independently operates in this engine. Attempts in designing this engine was devoted to proper location of parts and correct arrangement of the structure due to make utilization of an external heat source possible in an easy way.

Manufacturing this machine is possible by using ordinary facilities and equipment which has been used in production of pumps and engines in industry for decades. It has been considered in designing of the engine bearing that both ball bearings and oil lubricated bearings become applicable in this engine. In order to seal moving parts from gas leakage it has been considered that polymer sealant of PTFE be used. It has been considered to use water jackets for cooling engine and this water cycle will be used to cool down the operating gas in cold part of engine and complete the Stirling cycle.

Two series of similar pipes has been used in order to conduct the gas between the expansion and compression chamber of each cylinder. Because the pipes are identical in shape and size, both are identified by number 35. These pipes are indicated by number 39 in one end where it's connected to an expansion chamber of cylinder and the other end is indicated with number 38 where it's connected to a compression chamber in the other cylinder. In the location indicated with number 25 on the pipes, gas absorbs heat from a heat source and repels the heat in location number 37 in order to complete the Stirling cycle. There is neutral fluid or in better words a non-operating gas in chambers indicated by number 34. This gas doesn't have any contribution to Stirling cycle and these mentioned chambers are connected to a buffer vessel.

In this innovation the goals were to design a double acting engine which operates by a Stirling cycle more over the weak points and problems of previous double acting Stirling engines be solved.

Utilizing this new layout for the engine, all seals are located in cold zones which make producing this engine easier and cheaper. Also materials needed for preventing gas leakage in this engine has become more ordinary and cheaper in comparison with previous models.

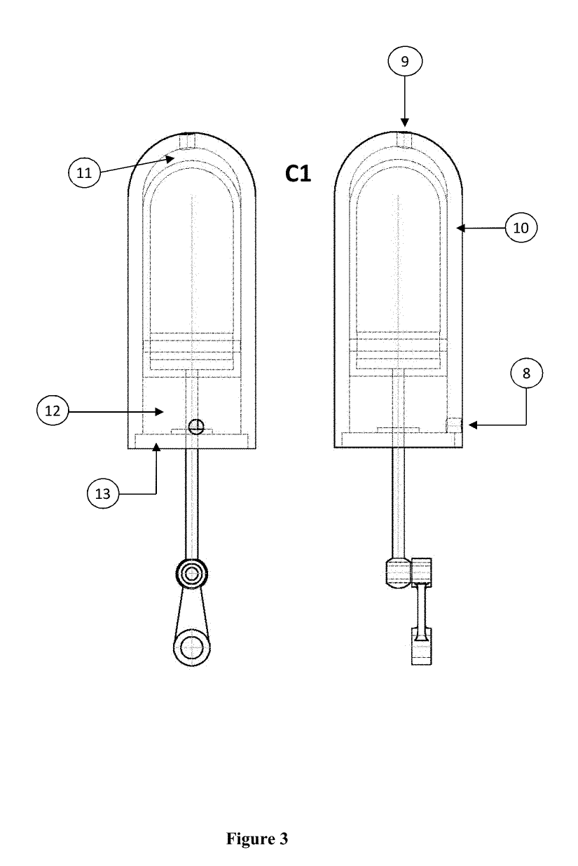

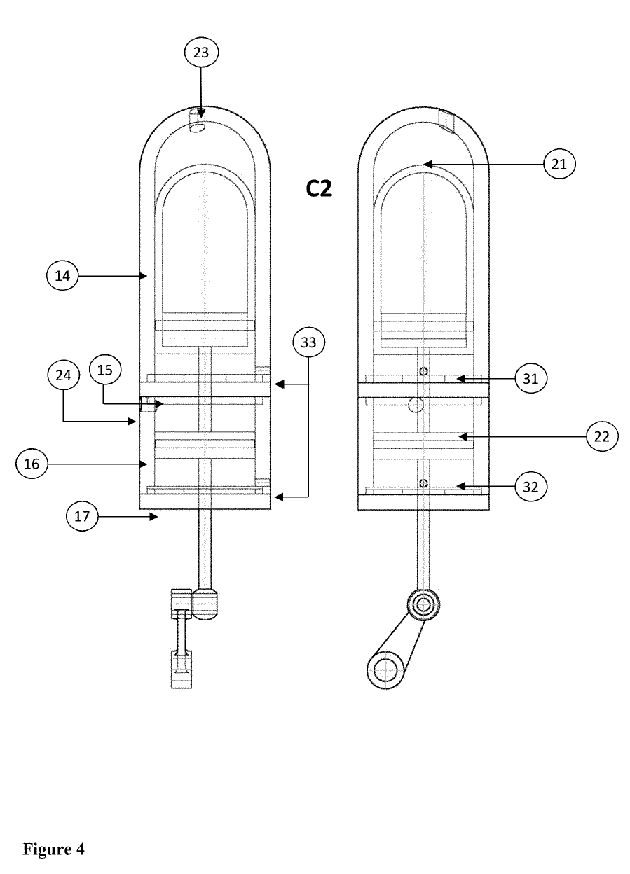

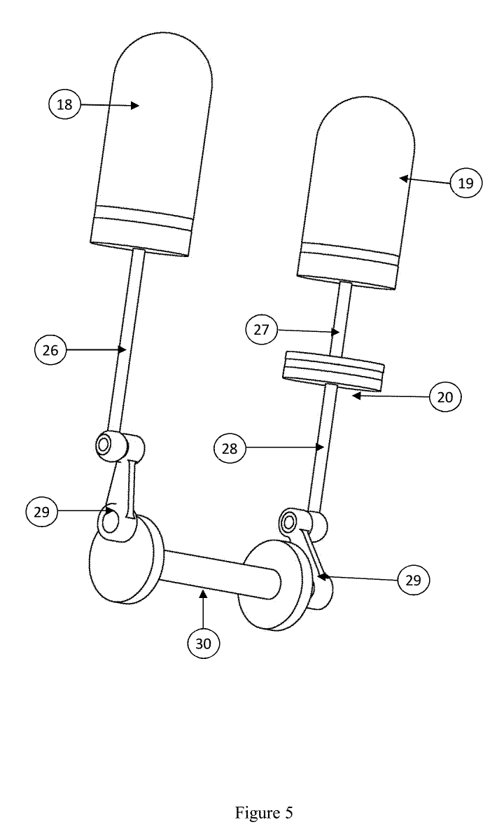

Piston P1 in cylinder C1 reciprocate with 90 degrees phase offset according to pistons in cylinder C2. There is no phase offset between pistons PB1 & PB2 in cylinder C2. These two cylinders are similar in bore diameter but different in structure. Also pistons inside these two cylinders are the same in diameter but different in structure. Cylinder in which there is only one piston reciprocating is named cylinder “C1”. It consists of cylinder body 10 and bottom cap 13 (FIG. 3). There is an expansion chamber on top—indicated by number 11- and there is a compression chamber at bottom of the cylinder—indicated by number 12. Both of these two chambers are swept by means of piston “P1”—indicated by number 18—.

The other cylinder is named “C2”. This cylinder consists of a cylinder upper body 14, cylinder separator wall 15, cylinder lower body 16 and Bottom cap 17. Pistons which are reciprocating inside it are

$$\frac{π}{2}$$

radian delayed in comparison with phase of piston in cylinder C1. Cylinder C2 is different in shape and structure with cylinder C1. Expansion chamber of cylinder C2—indicated by number 21—is located in the top of this cylinder and this chamber is swept by piston “PB1”. Piston PB1 is indicated by number 19. There is a separator wall—number 15—under piston PB1 and in the middle of cylinder C2. This wall separates space under piston PB1—indicated by number 31—from compression chamber of cylinder C2—indicated by number 22—. Under the separator wall there is the compression chamber of cylinder C2—number 22- and piston PB2—indicated by number 20—which sweeps this chamber. Piston PB2 is connected to piston PB1 with a rigid push rod—indicated by number 27—.

Both pistons in cylinder C2 reciprocate in phase (without phase difference) because of this connection, therefore they will sweep their relative chambers—numbers 22 & 21—simultaneously and without phase difference. Consequently expansion chamber number 11 is connected to compression chamber number 22 by means of gas pipe, also Compression chamber number 12 is connected to expansion chamber number 21 by means of other gas pipe as well, in order to complete the Stirling cycles in this engine.

These mentioned pipes are both similar in shape but they connect two different Stirling cycles separately. Because these pipes are similar in shape, both of them are indicated by number 35. There is a push rod under each cylinder which connects piston to a connecting rod. Piston P1 is connected to the connecting rod by means of push rod number 26 and piston PB2 is connected to connecting rod by push rod number 28.

Both connecting rods are similar and indicated by number 29. Connecting rods are connected to crank shaft which is indicated by number 30. In addition this is possible to use a crosshead for each connecting rod in the joint between push rod and connecting rod. Moreover a regenerator part—indicated by number 36—is placed between hot zone of pipes—indicated by number 25- and cold zone of pipes—indicated by number 37—as it is common in Stirling engines. A buffer vessel exists in this engine—indicated by number 34—which is connected to non-operating gas chambers—indicated by number 31 & 32—under pistons PB1 and PB2. This buffer vessel is intended to connect the non-operating gas of engine to a larger space.

Thermodynamic media or operating fluid in this engine is a gas and can be selected from different type of gases. Pistons are sealed in locations between piston and cylinder walls—parts number 10 & 14 & 16—. Also push rods are sealed in parts indicated by numbers 13 &15 & 17. Water jackets can be prepared around cylinders and cold pipes in order to cool them down.

Ball bearings are used for bearing between connecting rods and crankshafts although other types of bearings can be used instead. It shouldn't be neglected that crankshaft mechanism can be substituted by swash plate mechanism.

As P1 piston moves downward it expands the chamber number 11 in the top of cylinder C1 and compresses the chamber number 12 in the bottom of that cylinder. Cylinder C2 is different with the cylinder C1 in structure and layout of chambers. In cylinder C2 the compression chamber is in the top of this cylinder and this chamber is swept by a piston under this chamber which is named piston PB1. As mentioned above, there is a wall—indicated by number 15—in the middle of cylinder C2. The space above this wall is a neutral chamber—No. 31—which this chamber is under PB1 piston.

The gas in this chamber doesn't do any action related to Stirling cycle so that it is named non-operating gas. Under the separator wall there is a compression chamber—indicated by number 22—which is swept by another piston which named PB2 and is located in the lower part of cylinder C2—16 —. It is worth to be mentioned that pistons PB1 & PB2 are connected to each other by means of a rigid rod 27 which goes through the separator wall. So that this rigid wall causes these two pistons reciprocate in phase. There is also another neutral chamber under PB2 piston which is indicated by number 32. Non-operating gas pressure in chambers 31&32 exerts a destructive force against piston movement when pistons PB1 & PB2 are traveling downward.

This destructive force reduces the performance of engine thus these two neutral chambers are connected to a larger vessel through the openings number 33. This vessel is indicated by number 34 and is named buffer vessel. This vessel reduces the destructive force against pistons to an acceptable level.

From the opening number 24, chamber number 22 is connected to the gas pipe(s)—number 35- and the other end of pipe(s) are connected to the chamber number 11 from opening number 9 in order to complete one of the Stirling cycles. The chamber number 21 is connected to the gas pipe(s) from opening number 23 and the other end of pipe(s) is connected to the chamber number 12 from the opening number 8 due to complete the other Stirling cycle. In this engine these two Stirling cycles are enough to make the engine work correctly. But in common double acting Stirling engines at least four cycles are demanded.

If we consider the reciprocating movement of pistons as the spot on the SIN θ diagram (FIG. 19) and θ is phase of revolving, then movement of pistons and Stirling cycle can be analyzed as below.

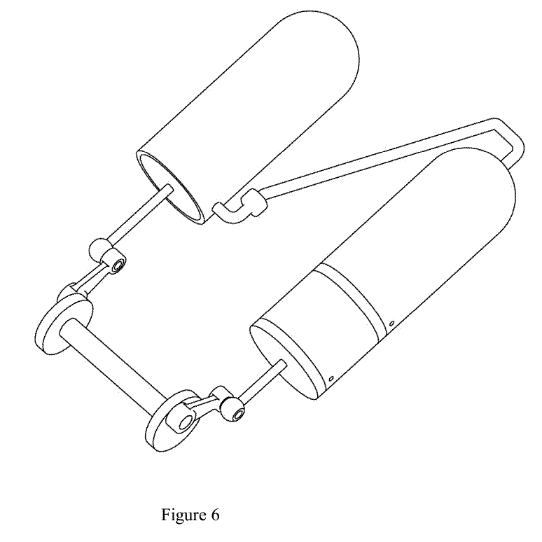

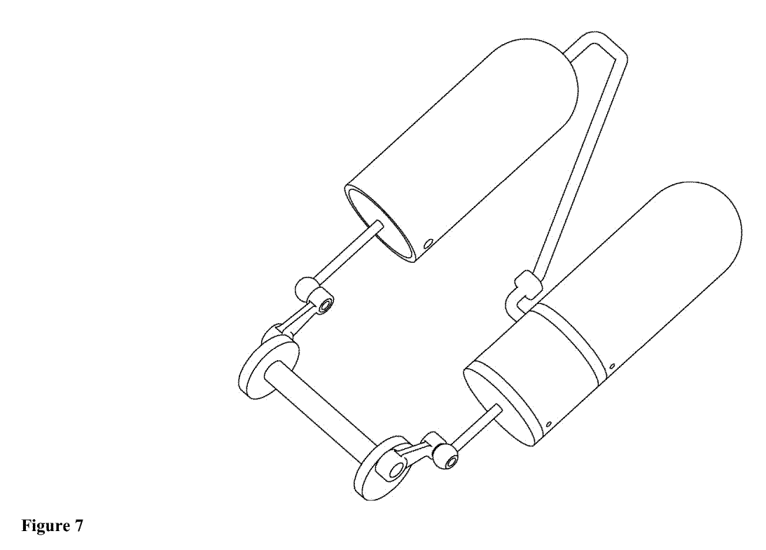

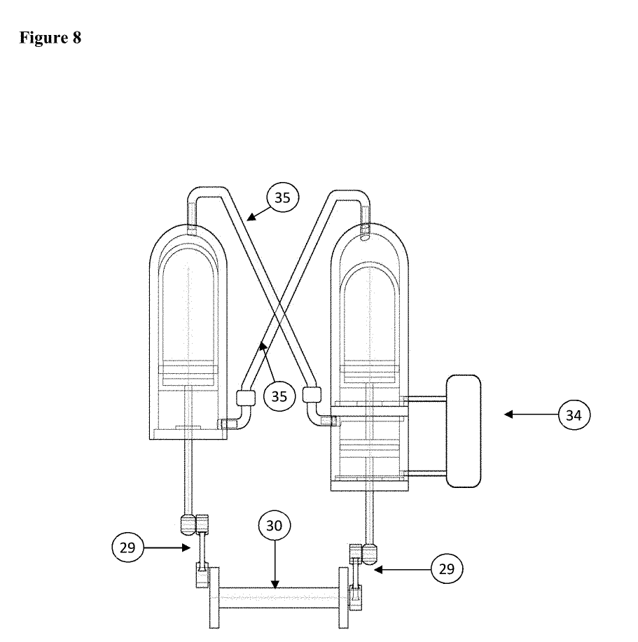

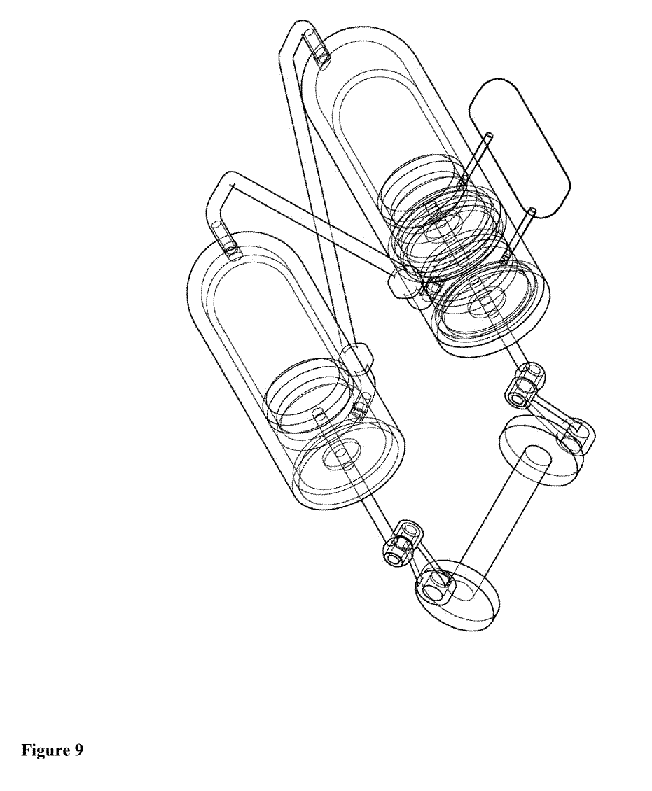

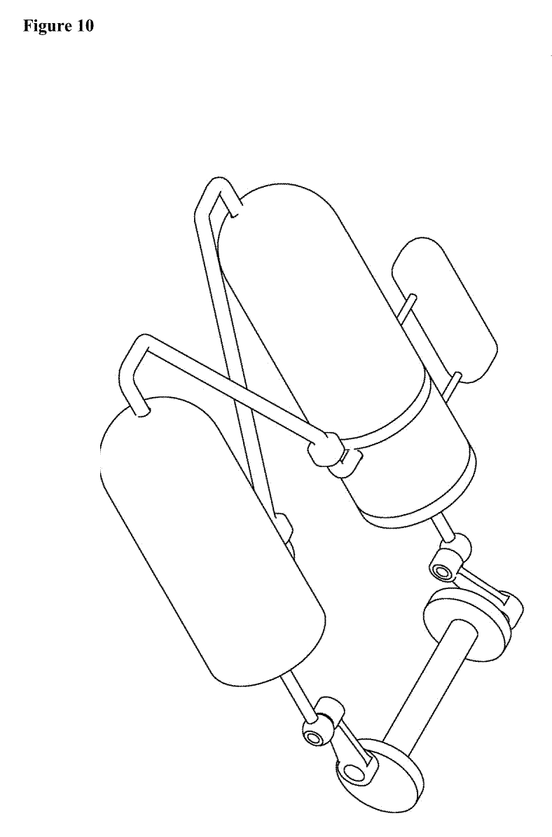

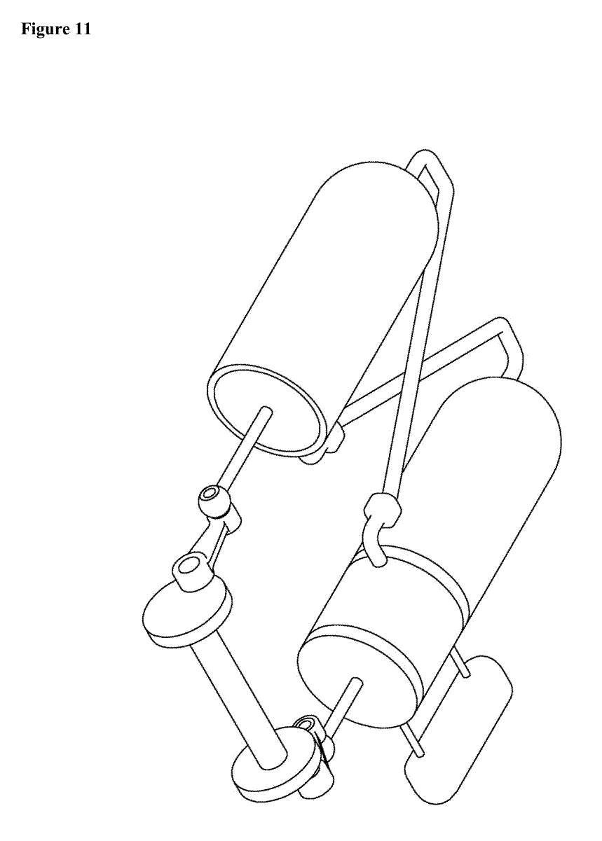

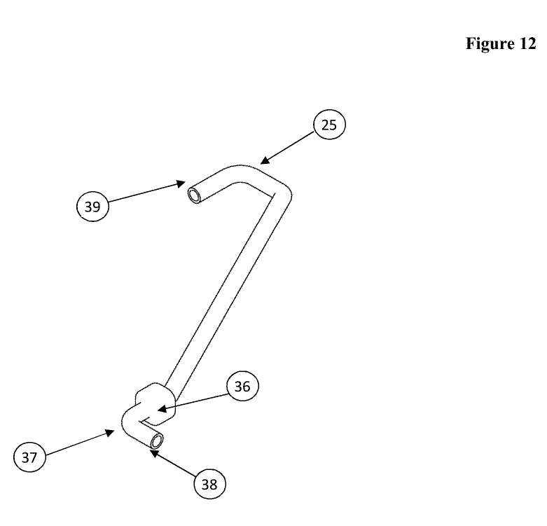

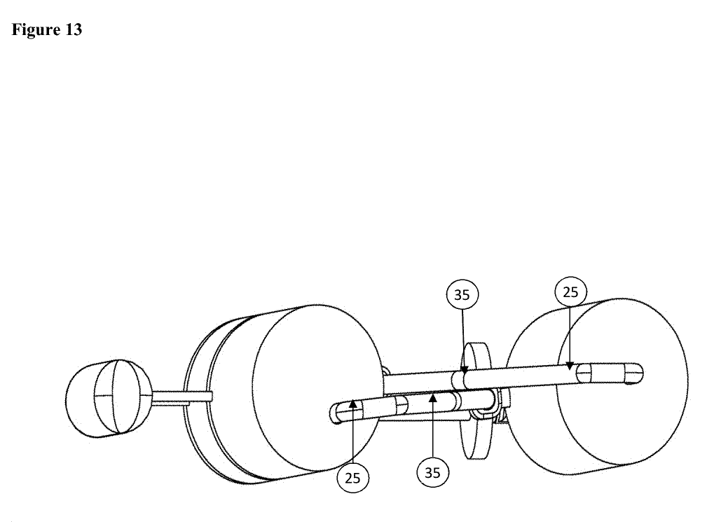

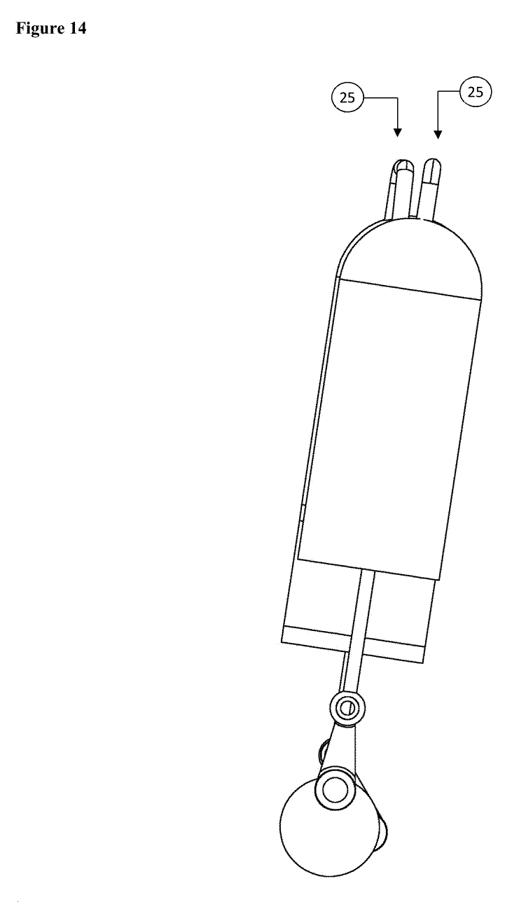

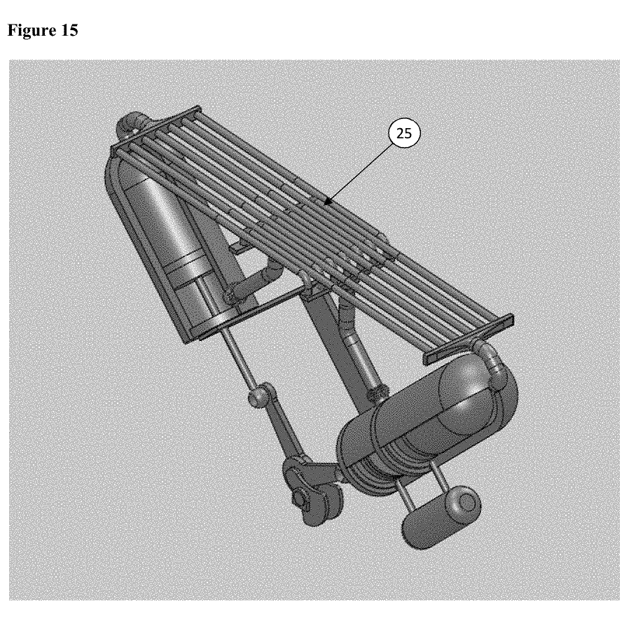

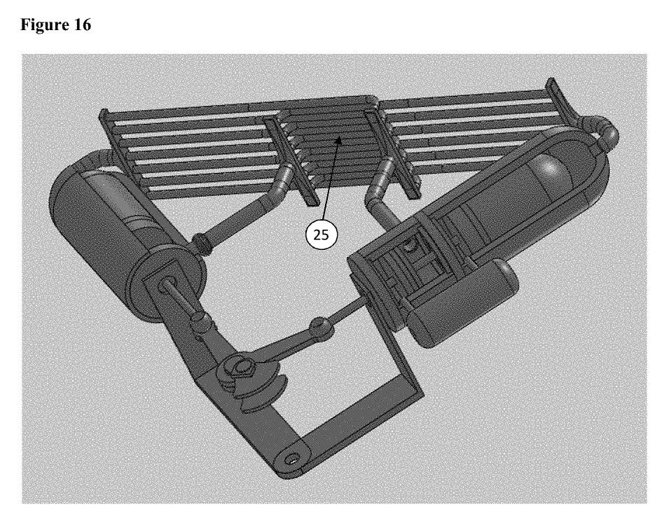

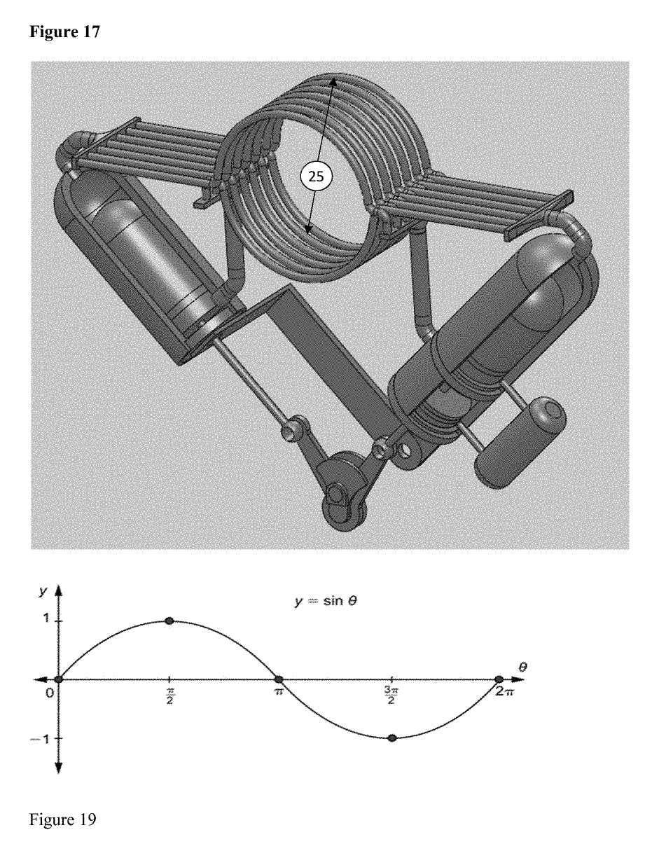

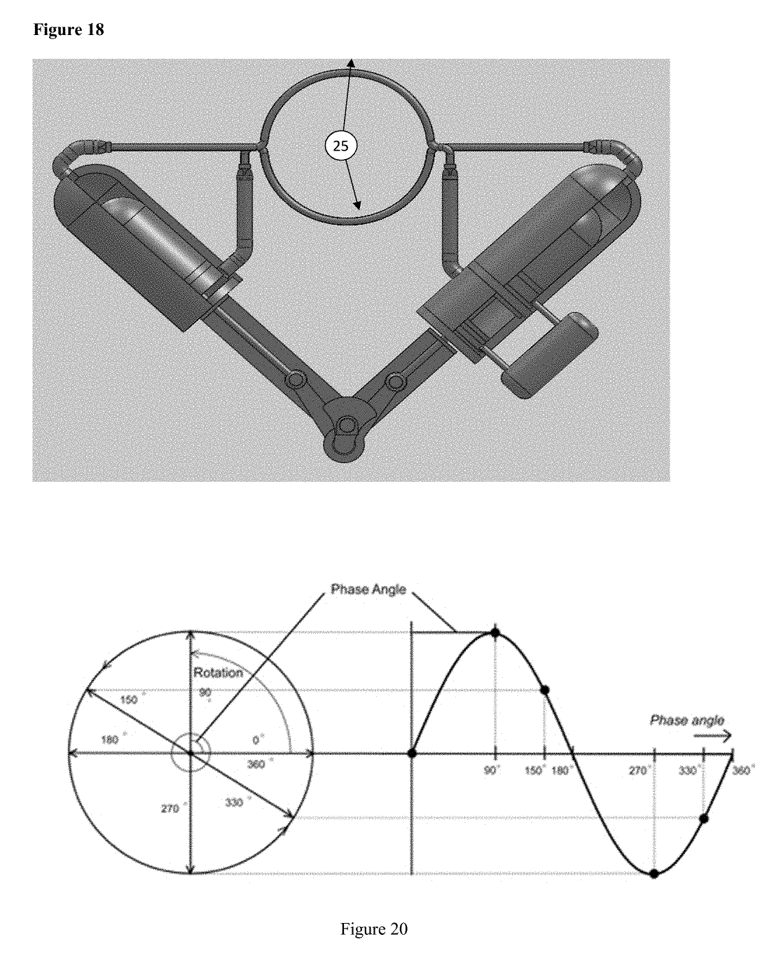

In order to better understand the mechanism of engine two gas paths are separately studied. One of the paths which is named Path1 (shown in FIG. 6) is comprised of the gas path between chamber 21 in the top of cylinder C2 and chamber 12 in the bottom of cylinder C1. The other path which connects chamber 22 in the middle of cylinder C2 to the chamber 11 in the top of cylinder C1 is named Path2 (shown in FIG. 7).

Since we want to prove that both of Stirling cycles operate correctly as and produce work from heat, we analyze both cycles for clockwise revolution of crank shaft. It must be mentioned that if one of cycles operates as a Stirling refrigerator, the engine wouldn't work. So in this analyze we want to show both of these two Stirling cycles work as Stirling engine.

We name these two cycles after the paths which each cycle is connected to. First we will analyze Cycle2. Cycle2 is named after Path2 (FIG. 7) which comprise of compression chamber no. 22 above piston PB2 in the middle of cylinder C2 and expansion chamber no. 11 above piston P1. Cycle2 is analyzed as below:

In this cycle piston P1 leads piston PB2 with

$$\frac{π}{2}$$

radian phase difference. Step 1: At the time P1 piston is in phase of

$$\frac{π}{2}$$

radian, it means that the piston is in Top Dead Center (TDC). At this moment, this piston is on the threshold of traveling downwards. The expansion chamber no. 11 above this piston is empty at this moment. At this moment piston_PB2 is in phase of zero or 2π radian and is moving upwards to compress the fluid in compression chamber no. 22 above piston PB2.

Step 2: As the crankshaft revolves

$$\frac{π}{2}$$

radian counter clockwise, piston P1 reaches the phase position of π radian and it is moving downwards because of expansion force of gas in chamber no. 11. At this moment piston PB2 is in phase of

$$( \frac{π}{2} )$$

which means it is in Top Dead Center (BDC). At this moment piston PB2 is on the threshold of moving downwards because of the pressure of gas in chamber no. 22 which produces downward force above piston PB2. In this situation both pistons are forced downward by the pressure in their correspondent chambers.

Step 3: After

$$\frac{π}{2}$$

radian counter clockwise revolving of crankshaft, P1 piston will reach the phase of

$$\frac{3 π}{2}$$

radian mat is BDC. Therefore expansion chamber no. 11 is expanded to the maximum volume it can achieve. It is on the threshold of moving upwards. At this moment piston PB2 is in phase of π, moving downwards in order to fill the compression chamber no. 22.

Step 4: By

$$\frac{π}{2}$$

radian counter clockwise revolving of crankshaft, piston P1 starts purging the gas in chamber no. 11 and will reach the phase zero or 2π. At this moment piston PB2 is in BDC and is in the threshold of traveling upwards to compress the gas in compression chamber no. 22.

Finally when the crankshaft revolves

$$\frac{π}{2}$$

radian counter clockwise, a 360 degree cycle is completed and both of pistons will reach their initial positions in step 1. If the cycle revolves vice versa, it would work as a Stirling refrigerator.

Note: In the Stirling engine cycle, the expansion chamber is located in hot zone of cylinder and compression chamber is located in cold zone of cylinder. Any action as compression, expansion, purging and else which takes place in hot chamber (generally known as expansion chamber) will take place in the other chamber which is cold (generally known as compression chamber) with a phase difference of

$$\frac{π}{2}$$

radian.

For instance if the expansion chamber is on the threshold of being purged by its piston, therefore after

$$\frac{π}{2}$$

radian revolving of crankshaft the compression chamber will be on the threshold of being purged. According to this explanation and analyze below, it can be understood that cycle1 works as a Stirling engine cycle as well as cycle2.

Cycle1 is named after Path1 (FIG. 6) which comprise of expansion chamber no. 21 above piston PB1 and compression chamber no. 12 under piston P1. Cycle 1 is analyzed as below:

In this cycle piston P1 leads piston PB1 with

$$\frac{π}{2}$$

radian phase difference as well as Cycle 2. But the difference is piston P1 purges the chamber when it is moving downwards; contrary to cycle2 that piston P1 purges the chamber when it is traveling upwards. This contrast will make a virtual π radian phase difference that makes P1 piston act vice versa. This means although it seems piston P1 is leading piston PB1, actually the chambers are being purged as piston PB1 is leading piston P1.

Step 1: At the time PB1 piston is in phase of

$$\frac{π}{2}$$

radian, it means that the piston is in Top Dead Center (TDC). At this moment, this piston is on the threshold of traveling downwards. The expansion chamber no. 21 above this piston is empty at this moment. At this moment piston P1 is in phase of π radian and is moving downwards to compress the fluid in compression chamber no. 12 under piston P1.

Step 2: As the crankshaft revolves

$$\frac{π}{2}$$

radian counter clockwise, piston PB1 reaches the phase position of π radian and it is moving downwards because of expansion force of gas in chamber no. 21. At this moment piston P1 is in phase of

$$( \frac{3 π}{2} )$$

which means it is in Bottom Dead Center (BDC). At this moment piston P1 is on the threshold of moving upwards because of the pressure of gas in chamber no. 12 which produces upward force under piston P1. In this situation both pistons are forced back by the pressure in their correspondent chambers.

Step 3: After

$$\frac{π}{2}$$

radian counter clockwise revolving of crankshaft, PB1 piston will reach the phase of

$$\frac{3 π}{2}$$

radian that is BDC. Therefore expansion chamber no. 21 is expanded to the maximum volume it can achieve. It is on the threshold of moving upward. At this moment piston P1 is in phase of zero or 2π, moving upwards in order to fill the compression chamber no. 12.

Step 4: By

$$\frac{π}{2}$$

radian counter clockwise revolving of crankshaft, piston PB1 starts purging the gas in chamber no. 21 and will reach the phase zero or 2π. At this moment piston P1 is in TDC and is in the threshold of traveling downwards to compress the gas in compression chamber no. 12.

Finally when the crankshaft revolves

$$\frac{π}{2}$$

radian counter clockwise, a 360 degree cycle is completed and both of pistons will reach their initial positions in step 1.

Thermodynamic fluid in Stirling engines can be chosen from a wide range of gases, but Helium which increases the performance and efficiency is more usual in Stirling engines. As it was mentioned above in the text, crankshaft mechanism can be replaced by swash plate mechanism in this engine.

The current invention has a better heat gathering and radiation absorption for solar dish application as well as an Alpha single acting engine. It is more efficient due to less dead spaces in its cylinders. Frictional loss is reduced because of fewer moving parts. Also by using one crankshaft instead of two separated crankshafts and a drive shaft or a swash plate which is commonly used in four cylinder double acting engines; decreases the frictional loss during performance and provides more simplicity. It has less sealing and bearing compared to a Siemens type and also lower costs of manufacturing because of less parts. It has a Smaller fly wheel and starter system is required in comparison with a single acting engine.

1- A two cylinder double acting Stirling engine, comprises three pistons, a first piston reciprocating in a first cylinder and second and third pistons reciprocating in a second cylinder; wherein a first pipe extends from an expansion chamber of said first cylinder and is connected on another end to a compression chamber of said second cylinder and vice versa, a second pipe extends on one end from an expansion chamber of said second cylinder and is connected on another end to a compression chamber of said first cylinder; wherein said first piston in said first cylinder reciprocates with a 90° phase offset in comparison with said second and third pistons of said second cylinder; and wherein there is no phase offset between said second and third pistons.

2- The Stirling engine of claim 1, wherein said first, second and third pistons have equal diameters but different structures, and wherein said first and second cylinders are similar in bore diameter but different in structure.

3- The Stirling engine of claim 2, wherein said second cylinder further comprises of a cylinder upper body, lower body, cylinder separator wall located at a middle of said second cylinder, wherein said second piston is located at an upper half of said second cylinder above said wall and wherein said third piston is located at a bottom half of said second cylinder below said wall creating said second compression chamber.

4- The Stirling engine of claim 3, wherein said second and third pistons are connected to each other via a rigid push rod, which is passed through said separator wall.
